(19) United States
(12) Patent Application Publication
(10) Pub. No.: US 2025/0242408 A1
(43) Pub. Date: Jul. 31, 2025

(54) ADDITIVE MANUFACTURING REMOVAL AND REPLACEMENT OF FEATURE TO ENABLE ACCESS DURING DIRECTED ENERGY DEPOSITION REPAIR PROCESS

(71) Applicant: RTX Corporation, Farmington, CT (US)

(72) Inventor: Peter Breitzmann, Aldie, VA (US)

(21) Appl. No.: 18/424,230

(22) Filed: Jan. 26, 2024

(51) Int. Cl. B22F 7/06; B22F 5/00; B23P 6/00; B33Y 10/00; B33Y 80/00

(52) U.S. Cl. CPC B22F 7/062; B22F 5/009; B23P 6/007; B22F 2007/068; B33Y 10/00; B33Y 80/00

(57) ABSTRACT

An aerospace part, which is made from a base material, repairing using directed energy deposition (DED) techniques. The aerospace part is inspected to identify a worn or defective repair region on a repair feature that requires repair. An intervening feature that blocks line-of-sight from a DED laser/powder head to the repair region on the repair feature is removed such that after removal of the intervening feature there is line-of-sight from the DED laser/powder head to the repair region on the repair feature. a repair procedure is performed on the repair region of the repair feature using the DED laser/powder head. A replacement intervening feature is obtained and attached to the aerospace part to complete a desired repair. The aerospace part is returned to service after completion of the desired repair.

The present disclosure relates generally to repair of components and, more particularly, to an approach for removing a feature to enable access to a repair site.

It is often desirable to repair components used in a variety of applications, include aircraft propulsion applications, after they have suffered operations-related wear or damage due to use in the environments for which they were intended. While a variety of repair techniques are available, not all such components can be repaired using currently known techniques.

### SUMMARY

One aspect of this disclosure is directed to a method of repairing an aerospace part, which is made from a base material. The aerospace part is inspected to identify a worn or defective repair region on a repair feature that requires repair. An intervening feature that blocks line-of-sight from a directed energy deposition (DED) laser/powder head to the repair region on the repair feature is removed such that after removal of the intervening feature there is line-of-sight from the DED laser/powder head to the repair region on the repair feature. a repair procedure is performed on the repair region of the repair feature using the DED laser/powder head. A replacement intervening feature is obtained and attached to the aerospace part to complete a desired repair. The aerospace part is returned to service after completion of the desired repair.

### BRIEF DESCRIPTION OF THE DRAWINGS

FIG. 1 is a first schematic representation of an aerospace part that includes a feature that requires repair using directed energy deposition (DED) techniques.

FIG. 2 is a second schematic representation of an aerospace part that includes a feature that requires repair using directed energy deposition (DED) techniques.

FIG. 3 is a flowchart of the repair process of the present disclosure.

### DETAILED DESCRIPTION

While a wide variant of repair techniques are available for aerospace components that have suffered operations-related wear or damage due to use in the environments for which they were intended, not all components can be repaired using currently known techniques. For example, repair of aerospace components, such as gas turbine engine components, using directed energy deposition (DED) techniques requires line-of-site access to a site or feature in need of repair but line-of-site is not always available due to intervening features that block the line-of-site.

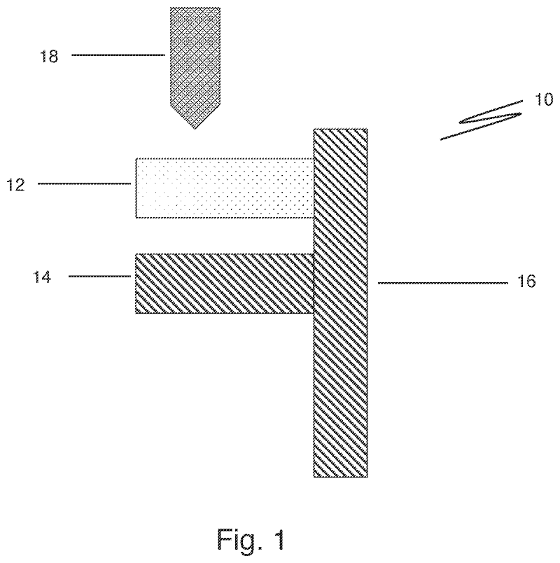

FIG. 1 is a schematic of an aerospace part 10 that includes a feature 14 that requires repair due to operational wear or damage. In this example, repair feature 14 is a candidate for repair using DED techniques (e.g., using DED laser/powder head 18), but line-of-sight from DED laser/powder head 18 is blocked by intervening feature 12. FIG. 1 depicts the aerospace part 10 and associated intervening feature 12 and repair feature 14 in generic form to emphasize the broad applicability of the disclosed repair method. The aerospace part 10, intervening feature 12, and repair feature 14 may be made from a base material as discussed further below. A person of ordinary skill well recognize parts that are candidates for repair using the disclosed repair method.

Line-of-sight from the DED laser/powder head 18 to the repair feature 14 can be provided by removing the intervening feature 12. Removal of the intervening feature 12 can be accomplished using any appropriate technique including mechanical cutting with a saw or abrasive material, wire electro-discharge machining (EDM) techniques, laser cutting, or other appropriate removal techniques.

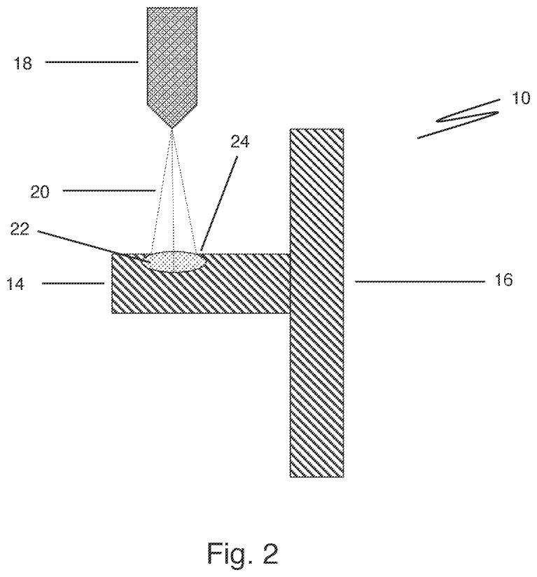

FIG. 2 shows is another schematic of aerospace part 10 with the intervening feature 12 (see FIG. 1) removed to provide line-of-site from the DED laser/powder head 18 to a repair region 24 of the repair feature 14. With the intervening feature 12 removed, repair region 24 of the repair feature 14 can be repaired by providing DED material powder and laser energy, shown collectively as item 20 in FIG. 2, from the DED laser/powder head 18 is to the repair region 24 of the repair feature 14 to accomplish the desired repair. A person of ordinary skill will know how to select the DED material powder and amount of energy produced by the DED laser/powder head 18 to raise the DED material powder to a temperature sufficient to form the melt pool 22 in the repair region 24. For example, the DED powder material may have the same composition as the base material or a different composition than the base material.

Also, a person of ordinary skill will know how to select the desired repair to address operational wear or damage to the repair feature 14. Examples of suitable repairs include (i) filling cracks in the repair region of the repair feature using a DED powder material distributed by the DED laser/powder head and consolidating the DED powder material using laser energy from the DED laser/powder head and (ii) reestablishing a worn surface contour in the repair region of the repair feature using a DED powder material distributed by the DED laser/powder head and consolidating the DED powder material using laser energy from the DED laser/powder head. In addition, a person of ordinary skill will know how to control the DED laser/powder head 18 to raster or scan over the DED material powder to form the melt pool 22 across the length and width of a repair region 24 of the repair feature 14 and to consolidate the melt pool 22 to accomplish the desired repair.

Once the desired repair to the repair feature 14 is accomplished, intervening feature 12 must be reestablished on aerospace part 10 before aerospace part 10 can be returned to service. Intervening feature 12 can be reestablished on aerospace part 10 using a variety of methods. For example, if Intervening feature 12 was removed from aerospace part 10 (as described above) substantially intact and is intervening feature 12 is otherwise in serviceable condition, intervening feature 12 can be reattached to aerospace part 10 using known techniques that are consistent with the operating requirements of the aerospace part 10, such as brazing, welding, or DED joining techniques that use the DED laser/powder head 18. If the original intervening feature 12 is not in serviceable condition, the intervening feature 12 can be reestablished using a replacement part that could be taken, for example, from an inventory of spare, replacement parts or can be fabricated as a new replacement part. In the latter situation, the replacement intervening feature 12 can be made using any available techniques including additive manufacturing (AM) techniques, including but not limited to powder bed fusion (PBF) techniques such a powder bed fusion-laser (PBF-L) or powder bed fusion-electron beam (PBF-EB) or even DED techniques. One advantage of making the replacement intervening feature 12 with PBF techniques is that the replacement intervening feature 12 can be made to near net shape such that the replacement material may, at most, require only limited machining before use. If DED techniques would be suitable for fabricating the replacement intervening feature 12, the DED laser/powder head 18 (see FIGS. 1 and 2) can be used to fabricate the replacement intervening feature 12 either separately for later attachment or in situ for direct attachment onto the aerospace part 10. Once the replacement intervening feature 12 has been attached to the aerospace part 10 by whatever method is selected, the aerospace part is a candidate for return to service.

A person of ordinary skill will recognize that the materials used for the repair to repair feature 14 and fabrication of replacement intervening feature 12 any of the materials typically used for the applications for which the aerospace part 10 is intended. For example, if the aerospace part 10 is used in a gas turbine application, the base material used to make the aerospace part 10 can be a titanium material for cold section (e.g., compressor) applications (see Table 1 for nonlimiting examples), a superalloy material for hot section (e.g., combustor and turbine) and disk applications (See Table 2 for nonlimiting examples), or specialty steels for other applications (e.g., shafts) (See Table 3 for nonlimiting examples). In most applications, the replacement intervening feature 12 will be made from the same base material as the aerospace part 10, most likely in a powder form that is useable with an AM technique used to make the replacement intervening feature 12. A person of ordinary skill will recognize that other materials can be used as the base material for the parts and method of this disclosure.

TABLE 1
Selected Titanium Alloys

| Grade designation | Nominal chemical composition |
|---|---|
| Ti64 | Ti—6Al—4V |
| Ti811 | Ti—8Al—1Mo—1V |
| Ti1100 | Ti—6Al—2.8Sn—4Zr—0.4Mo—0.4Si |
| Ti6242 | Ti—6Al—2Sn—4Zr—2Mo |
| Ti6242S | Ti—6Al—2Sn—4Zr—2Mo—0.2Si |

TABLE 2
Selected Superalloys

| Grade | |
|---|---|
| designation | Nominal chemical composition |
| Hastelloy X | Ni22Cr1.5Co1.9Fe0.7W9Mo0.07C0.005B |
| IN 100 | 60Ni10Cr15Co3Mo4.7Ti5.5Al0.15C 0.015B0.06Zr1.0V |
| IN 625 | 58.8Ni21.5Cr9Mo5Fe3.65Ni0.5Al0.5Ti0.05C0.5Mn0.5Si0.015S0.015P |
| IN 713 | 74.2Ni12.5Cr4.2Mo2Nb0.8Ti6.1Al0.1Zr0.12C0.01B |
| IN 718 | 53Ni19Cr18.5Fe3Mo0.9Ti0.5Al5.1Cb 0.03C |
| IN 738 | 61.5Ni16Cr8.5Co1.75Mo2.6W1.75Ta0.9Nb3.4Ti3.4Al0.04Zr0.11C0.01B |
| IN 792 | 60.8Ni12.7Cr9Co2Mo3.9W3.9Ta4.2Ti3.2Al0.1Zr0.21C0.02B |
| Rene 41 | 56Ni19Cr10.5Co9.5Mo3.2Ti1.7Al0.01Zr0.08C0.005B |
| Rene 77 | 53.5Ni15Cr18.5Co5.2Mo3.5Ti4.25Al0.08C0.015B |
| Rene 80 | 60.3Ni14Cr9.5Co4Mo4W5Ti3al0.03Zr0.17C0.015B |
| Rene 80 + Hf | 59.8Ni14Cr9.5Co4Mo4W0.8Hf4.7Ti3Al0.01Zr0.15C0.015B |
| Rene88 DT | 56.4Ni16cr13Co4Mo4W0.7Nb3.7Ti 2.1Al0.03C0.015B0.03Zr |
| Rene 95 | 61Ni14Cr8Co3.5Mo3.5W3.5Nb2.5Ti3.5Al 0.16C0.01B0.05Zr |
| Rene 100 | 62.6Ni9.5Cr15Co3Mo4.2Ti5.5Al0.06Zr0.15C0.015B |
| MERL-76 | 54.4Ni12.4Cr18.6co3.3Mo1.4Nb4.3Ti5.1Al0.02C0.03B0.35Hf0.06Zr |
| Udimet 720 | 55Ni18Cr14.8Co3Mo1.25W5Ti2.5Al0.035C 0.033B0.03Zr |
| Udimet 720LI | 57Ni16Cr15Co3Mo1.25W5Ti2.5Al0.025C0. 018B0.03Zr |
| MAR-M200 | 59.5Ni9Cr10Co12.5W1.8Nb2Ti5Al0.05Zr0.15C0.015B |
| MAR-M200 + Hf | Ni8Cr9Co12W2Hf1Nb1.9Ti5.0Al0.03Zr0.13C0.015B |
| MAR-M246 | 59.8Ni9Cr10Co2.5Mo10W1.5Ta1.5Ti5.5Al0.05Zr0.14C0.015B |
| MAR-M246 + Hf | Ni9Cr10Co2.5Mo10W1.5Hf1.5Ta1.5Ti5.5Al0.05Zr0.15C0.015B |
| Udimet 700 | 59Ni14.3Cr14.5Co4.3Mo3.5Ti4.3Al0.02Zr0.08C0.015B |
| Udimet 710 | 54.8Ni18Cr15Co3Mo1.5W2.5Ti5Al0.08Zr0.13C |
| Waspaloy | 58Ni19Cr13Co4Mo3Ti1.4Al |

TABLE 3
Selected Specialty Steels

| Grade designation | Nominal chemical composition |
|---|---|
| CrMoV steel | Fe1Cr0.5Ni1.25Mo0.25V0.30C |
| M152 | Fe12Cr2.5Ni1.7Mo0.3V0.12C |

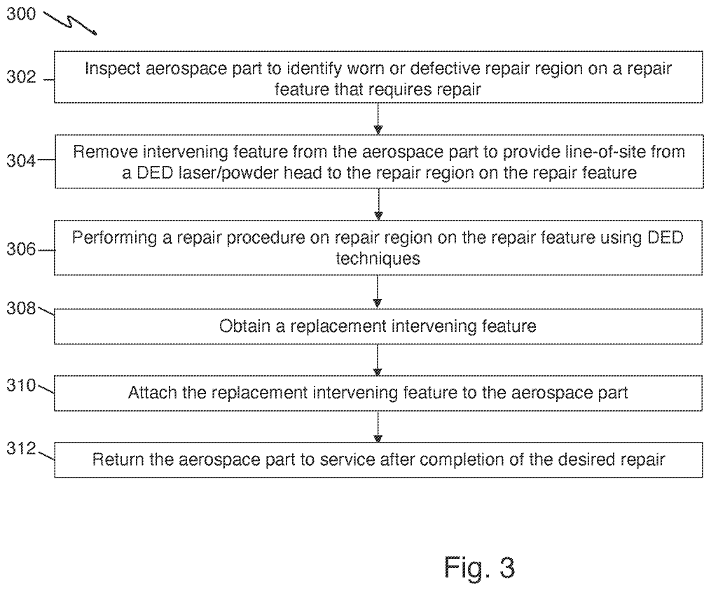

FIG. 3 is a flowchart of the overall repair procedure 300 of this disclosure. At step 302, the aerospace part 10 is inspected to identify a worn or defective region on the repair feature 14 that requires a repair. At step 304, an intervening feature 12 is removed from the aerospace part 10 to provide line-of-site from a DED laser/powder head 18 to the repair region 24 of the repair feature 14 as discussed above. worn or defective features that need to be replaced are removed from the original part. At step 306, the repair region 24 on the repair feature 14 is repaired using DED techniques. At step 308, a replacement intervening feature 12 is obtained as discussed above, for example by using the original intervening feature 12, by using a part from an inventory of replacement parts, or by fabricating a replacement intervening feature 12. As discussed above the replacement intervening feature 12 can be fabricated using AM techniques, including but not limited to PBF techniques and DED techniques. At step 310, the replacement intervening feature 12 is attached to the aerospace part 10. Finally, at step 312 the aerospace part 10 is returned to service after completion of the desired repair. A person of ordinary skill will know how to perform each of these steps based upon the present disclosure and knowledge of manufacturing processes.

Using the repair technique described in this disclosure, DED techniques can be used to repair aerospace parts 10 that would not otherwise be eligible for DED repairs due to line-of-site from a DED laser/powder head 18 being blocked by an intervening feature 12. As a result, the number of available repair methods for aerospace parts 10 is expanded.

### Discussion of Possible Embodiments

The following are non-exclusive descriptions of possible embodiments of the present invention.

A method of repairing an aerospace part incudes inspecting the aerospace part, which is made from a base material, to identify a worn or defective repair region on a repair feature that requires repair. An intervening feature that blocks line-of-sight from a directed energy deposition (DED) laser/powder head to the repair region on the repair feature is removed from the aerospace part such that after removal of the intervening feature there is line-of-sight from the DED laser/powder head to the repair region on the repair feature. A repair procedure is performed on the repair region of the repair feature using the DED laser/powder head. A replacement intervening feature is obtained and attached to the aerospace part to complete a desired repair. The aerospace part is returned to service after completion of the desired repair.

The method of the preceding paragraph can optionally include, additionally and/or alternatively, any one or more of the following features, configurations and/or additional elements:

The method of the preceding paragraph, wherein the base material comprises a titanium alloy, a superalloy material, or a specialty steel alloy.

The method of the any of the preceding paragraphs, wherein the repair procedure includes filling cracks in the repair region of the repair feature using a DED powder material distributed by the DED laser/powder head and consolidating the DED powder material using laser energy from the DED laser/powder head.

The method of the preceding paragraph, wherein the DED powder material has the same composition as the base material.

The method of the preceding paragraph, wherein the DED powder material has a different composition as the base material.

The method of the any of the preceding paragraphs, wherein the repair procedure includes reestablishing a worn surface contour in the repair region of the repair feature using a DED powder material distributed by the DED laser/powder head and consolidating the DED powder material using laser energy from the DED laser/powder head.

The method of the preceding paragraph, wherein the DED powder material has the same composition as the base material.

The method of the preceding paragraph, wherein the DED powder material has a different composition as the base material.

The method of the any of the preceding paragraphs, wherein the replacement intervening part is the original intervening part, a replacement intervening part obtained from an inventory of replacement parts, or a newly fabricated replacement part.

The method of the preceding paragraph, wherein the replacement intervening part is a newly fabricated part made with additive manufacturing (AM) techniques.

The method of the preceding paragraph, wherein the AM techniques include powder bed fusion (PBF) techniques or DED techniques.

The method of the preceding paragraph, wherein the replacement intervening part is made from the base material.

The method of the preceding paragraph, wherein the replacement intervening part is made from a different material then the base material.

The method of the preceding paragraph, wherein the replacement intervening part is fabricated in situ on the aerospace part using DED techniques.

The method of the preceding paragraph, wherein the replacement intervening part is attached to the aerospace part using DED joining techniques.

The method of the any of the preceding paragraphs, wherein the aerospace part is a component of a gas turbine engine.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of repairing an aerospace part, comprising:
inspecting the aerospace part to identify a worn or defective repair region on a repair feature that requires repair, wherein the aerospace part is made from a base material;
removing from the aerospace part an intervening feature that block line-of-sight from a directed energy deposition (DED) laser/powder head to the repair region on the repair feature, wherein after removal of the intervening feature there is line-of-sight from the DED laser/powder head to the repair region on the repair feature;
performing, using the DED laser/powder head, a repair procedure on the repair region of the repair feature;
obtaining a replacement intervening feature;
attaching the replacement intervening feature to the aerospace part to complete a desired repair;
returning the aerospace part to service after completion of the desired repair.

2. The method of claim 1, wherein the base material comprises a titanium alloy, a superalloy material, or a specialty steel alloy.

3. The method of claim 1, wherein the repair procedure includes filling cracks in the repair region of the repair feature using a DED powder material distributed by the DED laser/powder head and consolidating the DED powder material using laser energy from the DED laser/powder head.

4. The method of claim 3, wherein the DED powder material has the same composition as the base material.

5. The method of claim 3, wherein the DED powder material has a different composition as the base material.

6. The method of claim 1, wherein the repair procedure includes reestablishing a worn surface contour in the repair region of the repair feature using a DED powder material distributed by the DED laser/powder head and consolidating the DED powder material using laser energy from the DED laser/powder head.

7. The method of claim 6, wherein the DED powder material has the same composition as the base material.

8. The method of claim 6, wherein the DED powder material has a different composition as the base material.

9. The method of claim 1, wherein the replacement intervening part is the original intervening part, a replacement intervening part obtained from an inventory of replacement parts, or a newly fabricated replacement part.

10. The method of claim 9, wherein the replacement intervening part is a newly fabricated part made with additive manufacturing (AM) techniques.

11. The method of claim 10, wherein the AM techniques include powder bed fusion (PBF) techniques or DED techniques.

12. The method of claim 9, wherein the replacement intervening part is made from the base material.

13. The method of claim 9, wherein the replacement intervening part is made from a different material then the base material.

14. The method of claim 9, wherein the replacement intervening part is fabricated in situ on the aerospace part using DED techniques.

15. The method of claim 9, wherein the replacement intervening part is attached to the aerospace part using DED joining techniques.

16. The method of claim 1, wherein the aerospace part is a component of a gas turbine engine.
